(19) United States
(12) Patent Application Publication
(10) Pub. No.: US 2003/0029865 A1
(43) Pub. Date: Feb. 13, 2003

(54) Eared metal food-heating tray for microwave oven

(76) Inventor: C. J. Zhu, Bao An (CN)

Correspondence Address: CHRISTIE, PARKER & HALE, LLP, 350 WEST COLORADO BOULEVARD, SUITE 500, PASADENA, CA, 91105, US

(21) Appl. No.: 10/167,876

(22) Filed: Jun. 10, 2002

(30) Foreign Application Priority Data
Aug. 10, 2001 (CN) 01233932.6

(51) Int. Cl. H05B 6/80

(52) U.S. Cl. 219/732

(57) ABSTRACT

A kind of metal food-heating tray for microwave oven that comprising a metal tray, characterized in that insulating ears are symmetrically distributed on the edge of the metal tray. The eared metal food-heating tray for microwave oven in this utility model is scientific in design and reasonable in structure. The insulating ears on two sides of the tray can make the operation and utilization of metal tray more convenient and thereby the tray can be taken with hand regardless of the high temperature of the foods in the tray and the hotness of the tray itself. In order to make the metal food-heating tray applicable to microwave oven-used rotating trays made of different materials, insulating stands may be evenly distributed on the bottom surface of the eared metal food-heating tray for microwave oven in this utility model.

### CROSS REFERENCE TO RELATED APPLICATION

This application claims priority of Chinese Patent Application No. 01233932.6, filed on Aug. 10, 2001.

### TECHNICAL FIELD

The present utility model relates to a tray of microwave oven, especially a kind of eared metal food-heating tray for microwave oven.

### BACKGROUND TECHNOLOGY

As a new type of food heater, the microwave oven has been widely used among the consumers. The conventional rotating trays used in microwave ovens are made of glass to facilitate penetration of microwave. Therefore, non-metal trays are generally used for heating foods in the microwave oven. Said non-metal trays are generally thick glass trays or ceramic trays. With the advancement of researches on the heating principle of microwave oven, microwave oven rotating trays made of metallic materials have been put on the market, such as metal enamel rotating trays that are characterized by light weight and strong durability, and can fully satisfy the requirement of application as an auxiliary part of microwave oven in performance. Now that microwave oven can use metal enamel rotating tray, it's undoubted that metal tray can be used for containing foods. Therefore, metal food-heating trays for microwave oven have appeared in the market. Metal food-heating trays are advantageous because they are thinner, more compact, less fragile, and easier to clean. However, because of quick heat conduction, the metal tray may burn hand when it is taken out of the oven.

### CONTENT OF THE INVENTION

The present utility model eliminates the aforementioned defect of the metal food-heating tray by providing a kind of eared metal food-heating tray for microwave oven that is reasonable in structure and convenient for use.

The eared metal food-heating tray for microwave oven in the present utility model comprises a metal tray, characterizing insulating ears symmetrically distributed on the edge of the metal tray.

The eared metal food-heating tray for microwave oven in the present utility model is scientific in design and reasonable in structure. The insulating ears on two sides of the tray can make the operation and utilization of metal tray more convenient and thereby the tray can be taken with hand regardless of the high temperature of the foods in the tray and the hotness of the tray itself. In order the make the metal food -heating tray applicable to microwave oven-used rotating trays made of different materials, insulating stands may be evenly distributed on the bottom surface of the eared metal food-heating tray for microwave oven in this utility model.

The particular structure of the eared metal food-heating tray for microwave oven in this utility model are as shown in the following drawings and embodiment.

### BRIEF DESCRIPTION OF THE DRAWINGS:

FIG. 1: Structural schematic drawing of eared metal food-heating tray for microwave oven;

FIG. 2: Sectional view of the eared metal food-heating tray for microwave oven as shown in line A-A of Figure.

### THE OPTIMUM EMBODIMENT

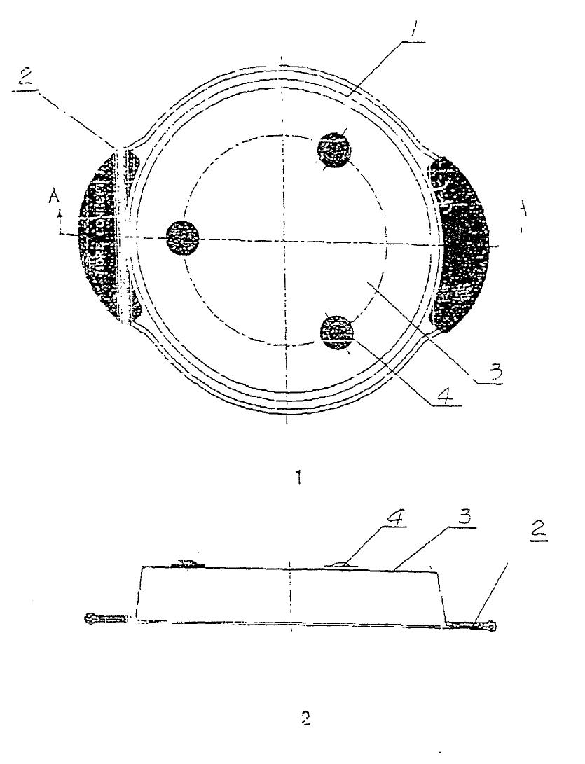

From FIG. 1 and FIG. 2, It is clearly shown that this is a circular metal food-heating tray; insulating ears 2 are symmetrically distributed on the edge of metal tray 1; there are insulating stands 4 on the bottom surface 3 of the metal tray 1; the insulating stands 4 are symmetrically distributed on the bottom surface 3 of the metal tray 1; the insulating ears 2 and the insulating stands 4 are stuck on the metal tray 1 through vulcanization. The said insulating ears 2 and the insulating stands 4 are made by rubber.

1. A kind of eared metal food-heating tray for microwave oven that includes a metal tray (1), characterized in that insulating ears (2) are symmetrically distributed on the edge of the metal tray (1).

2. The eared metal food-heating tray for microwave oven of claim 1, characterized in that insulating stands (3) are evenly distributed on the bottom surface (2) of the metal tray (1).

3. The eared metal food-heating tray for microwave oven of claim 1, characterized in that the insulating ears (2) and the insulating stands (4) are stuck on the metal tray (1) through vulcanization.

4. The eared metal food-heating tray for microwave oven of claim 1, characterized in that the insulating ears (2) and the insulating stands (3) are made by rubber.

5. The eared metal food-heating tray for microwave oven of claim 2, characterized in that the insulating ears (2) and the insulating stands (4) are stuck on the metal tray (1) through vulcanization.

6. The eared metal food-heating tray for microwave oven of claim 2, characterized in that the insulating ears (2) and the insulating stands (3) are made by rubber.
